(19) United States
(12) Patent Application Publication
(10) Pub. No.: US 2025/0200199 A1
(43) Pub. Date: Jun. 19, 2025

(54) FIRMWARE CONTROLLED SECRETS

(71) Applicant: Hewlett-Packard Development Company, L.P., Spring, TX (US)

(72) Inventors: Joshua Serratelli Schiffman, Washington, DC (US); Adrian Shaw, Bristol (GB); Jeffrey Kevin Jeansonne, Spring, TX (US)

(73) Assignee: Hewlett-Packard Development Company, L.P., Spring, TX (US)

(21) Appl. No.: 18/847,063

(22) PCT Filed: Apr. 12, 2022
(86) PCT No.: PCT/US2022/071668

§ 371 Date: Sep. 13, 2024

(51) Int. Cl. G06F 21/62; G06F 21/57; G06F 21/60; G06F 21/72

(52) U.S. Cl. CPC G06F 21/6209; G06F 21/572; G06F 21/575; G06F 21/602; G06F 21/72

(57) ABSTRACT

In an example, a computing device is described. The computing device comprises a component to perform a crypto-graphic operation and store an indication of a measured state of the computing device obtained during booting of the computing device. The computing device further comprises a processor to obtain a secret for use by the component, install an administration credential in a firmware of the computing device and transmit the secret to the component via the firmware.

### BACKGROUND

A component such as a trusted platform module (TPM) hosted by a computing device may record values indicative of a setup of the computing device based on measurements reported to the TPM during boot of the computing device. These values may be used to verify whether the setup is as expected.

### BRIEF DESCRIPTION OF DRAWINGS

Non-limiting examples will now be described with reference to the accompanying drawings, in which:

FIG. 1 is a simplified schematic drawing of an example computing device for controlling obtaining of a secret;

FIG. 2 is a simplified schematic drawing of an example computing device for controlling obtaining of a secret;

FIG. 3 is a simplified schematic drawing of an example computing device for controlling transmission of a secret to a cryptoprocessor;

FIG. 4 is a simplified schematic drawing of an example computing device for controlling transmission of a secret to a cryptoprocessor;

FIG. 5 is a simplified schematic drawing of an example computing device for controlling providing of a secret to a cryptoprocessor;

FIG. 6 is a simplified schematic drawing of an example computing device for controlling providing of a secret to a cryptoprocessor;

FIG. 7 depicts a flowchart of an example method of locking and unlocking of a trusted platform module via firmware for facilitating access to the trusted platform module; and

FIG. 8 depicts a flowchart of an example method of firmware controlled lock disabling.

### DETAILED DESCRIPTION

Disclosed herein are computing devices, machine readable media and methods that use secrets controlled by firmware.

A hardware component of a computing device may implement a security function (e.g., based on a cryptographic procedure and/or hard-wired security) to block or allow access to data stored in the hardware component itself or in another memory of the computing device, depending on whether or not the platform/user accessing such data is trusted by the hardware component. The computing device may comprise the hardware component or a combination of hardware components which may interact with each other in order to implement the functionality of the computing device. Examples of computing devices include personal computers, larger scale computers such as servers, smart phones, tablets and embedded systems such as used in printers, scanners, internet of things (IoT) devices, digital cameras, and the like.

As used herein, a hardware component for implementing a security function may be referred to as a “component to perform a cryptographic operation” or a “cryptoprocessor”. An example of a “component to perform a cryptographic operation” or a “cryptoprocessor” includes a “trusted platform module” (TPM), which may implement a specification of the Trusted Computing Group (TCG). Certain references to TPMs described herein may equally refer to a “component to perform a cryptographic operation” or a “cryptoprocessor”, even if not explicitly stated as such.

Some examples of other hardware components that may be used in a computing device include: a processor (e.g., central processing unit (CPU), field-programmable gate array (FPGA), application-specific integrated circuit (ASIC), and the like), a non-volatile memory (e.g., read-only memory (ROM), erasable programmable ROM (EPROM), electrically erasable programmable ROM (EEPROM), hard disk drive (HDD), flash drive, and the like), a volatile memory (e.g., random-access memory (RAM), and the like), a graphics card, an artificial intelligence (AI) chip, a network card (e.g., for wired and/or wireless networking), a hardware interface (e.g., for interfacing with another hardware component of the computing device and/or a peripheral that may be connectable to the computing device), other hardware for implementing a specified input/output function with respect to the computing device (e.g., a display device, camera, keyboard, mouse click/touch pad, fingerprint reader, speaker, microphone, and the like), and so on. In some examples, a computing device may integrate various hardware components on a platform where certain hardware components of the computing device may be removeable/replaceable within the platform. In some examples, a computing device may integrate a combination of various hardware components on a platform such as based on a system on a chip (SoC) architecture.

TPMs (and other components for performing cryptographic operations such as a cryptoprocessor) may be used store data such as user secrets and perform cryptographic functions e.g., to protect the data. In some examples, a TPM may be soldered onto the motherboard of a computing device and may be connected to the host CPU using a peripheral bus.

When a computing device is being manufactured, the original equipment manufacturer (OEM) may pre-populate the TPM with data which may be considered secret or sensitive, such as network access credentials, disk encryption keys, or other values. This may benefit the user because they may not have to perform the provisioning of such data on their own premises after receiving the computing device. Access to this data may be controlled by the firmware of the computing device. If a correct value (e.g., a measurement of a software, firmware and/or hardware state of the computing device) is extended into the TPM (e.g., via a hash of the measurement), this correct value may indicate a secure booting process (to thereby allow the data to be made accessible).

However, there may be certain security issues with TPMs and other components for implementing a security function.

In some examples, a physical attacker may be able to release data from the TPM. For example, the physical attacker may gain access to the data by physically moving the TPM to a platform they control. For example, an attacker may be able to remove the TPM from its platform and insert it into a different platform where the attacker has control of commands for interacting with the TPM. The attacker platform may extend expected values to mimic the original platform, to thereby facilitate release of the data.

In some examples, an attacker may be able to access data stored in the TPM, for example, if the attacker intercepts the computing device while it is in transit from a manufacturer or other authorized entity to an end user. Upon intercepting the computing device, the attacker may be able to override security controls or physically insert TPM commands on the bus. For example, if the TPM stores data such as a network access credential, the attacker could obtain the credential to gain access to a remote network. In some cases, data such as a network access credential may be intercepted by the attacker through use of an interposer device for manipulating TPM commands or issuing new TPM commands via the bus, which may result in the TPM releasing the data to the attacker.

In some examples, a TPM may implement a password or other authentication mechanism to control access to its data. However, such mechanisms may be controlled by the OS or a user application, which could be subverted by an attacker.

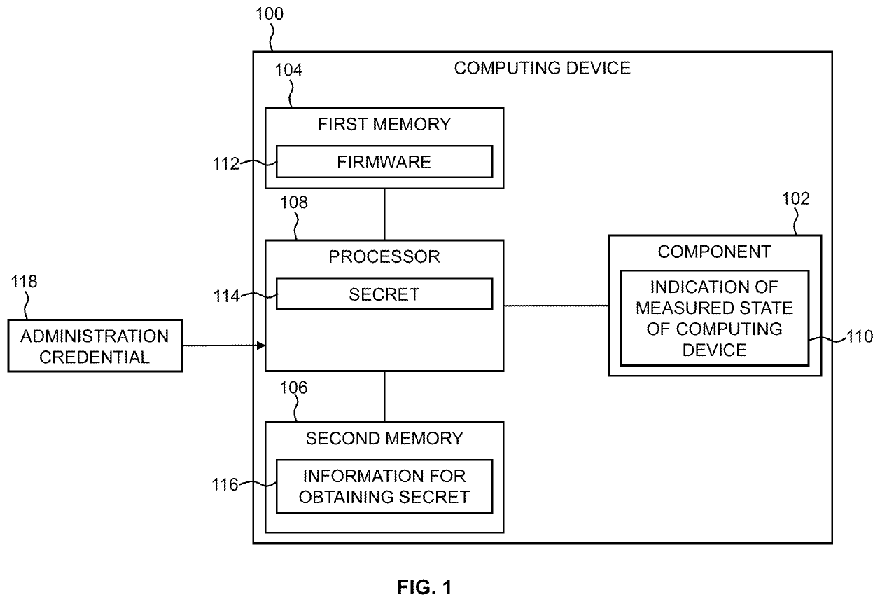

FIG. 1 is a simplified schematic drawing of an example computing device 100 for controlling obtaining of a secret. The secret may be useable to block release of data stored in a component 102 (e.g., a cryptoprocessor, TPM, or the like) of the computing device 100. While the data is blocked from being released from the component 102, the component 102 may be considered to be locked. Thus, the data stored in the component 102 may not be releasable (to another component of the computing device 100) while the component 102 is locked. However, as described in other examples below, the data stored in the component 102 may be released to another component of the computing device 100 based on use of the secret, as controlled by firmware of the computing device 100. In some examples, the locking of the component 102 may be performed in a trusted environment such as a factory where data for use by the end user of the computing device 100 may be pre-provisioned to the component 102.

As used herein, firmware refers to instructions executable by a processor of a computing device in order to implement certain functionality of the computing device. In some examples, a hardware component may comprise firmware for controlling certain functionality of the hardware component itself. In some examples, a hardware component may comprise firmware for controlling functionality of certain other hardware components of a computing device. In some examples, a hardware component may comprise firmware for initializing (e.g., booting) and/or controlling running of the hardware component itself (e.g., the firmware may provide certain functionality such as implementing an operating system (OS) for the hardware component, implementing controlling and/or monitoring of the hardware component, implementing data manipulation, and/or the like). In some examples, a hardware component may comprise firmware for initializing (e.g., booting) and/or implementing an environment in which more complex software (e.g., an OS) may be implemented on a computing device comprising the hardware component. In some examples, firmware may be stored in a non-volatile memory of a hardware component such as ROM, flash memory, and the like.

The computing device 100 comprises a first memory 104, a second memory 106 and a processor 108. The processor 108 is communicatively coupled to the component 102, first memory 104 and second memory 106. In some examples, the first memory 104 and second memory 106 are each provided by separate (first and second, respectively) storage devices of the computing device 100. In some examples, the first memory 104 and second memory 106 represent different allocated portions of memory in the same storage device.

In use of the computing device 100, the component 102 is to perform a cryptographic operation (e.g., as part of a security function for the computing device 100). Further, the component 102 is to store an indication 110 of a measured state of the computing device 100 obtained during booting of the computing device 100. In some examples, the indication 110 may be generated and stored (by the component 102) in response to an event that occurs during booting of the computing device 100. For example, a measurement relating to initialization of and/or determining an identity of a software, firmware and/or hardware component of the computing device 100 may be performed during booting of the computing device 100. Such a measurement may be reported to the component 102, which may generate and store the indication 110 based on the reported measurement. The measurement may be indicative of a state of the computing device 100. For example, the measurement may indicate whether an expected software/firmware version and/or hardware component is present on the computing device 100, and whether the computing device 100 is functioning as expected. The detected software/firmware version and/or hardware component may correspond to the state of the computing device 100. Thus, the indication 110 may also indicate whether the computing device 100 is functioning as expected (i.e., that it has the correct software/firmware version and/or hardware component installed).

The computing device 100 further comprises firmware 112 stored in the first memory 104.

In use of the computing device 100, the processor 108 is to obtain a secret 114 for use by the component 102. In this regard, the firmware 112 is to control obtaining of the secret 114 from information 116 stored in the second memory 106.

In some examples, the information 116 comprises the secret 114 itself. In some examples, the information 116 comprises a value such as a unique seed or other value that can be used to derive the secret 114 (e.g., based on a deterministic protocol or other protocol implemented by the firmware 112 for determining the secret 114 based on the information 116). In both examples, the firmware 112 may thus obtain the secret 114 based on the information 116.

The secret 114 is associated with the computing device 100. For example, the secret 114 may be provisioned to the computing device 100 (e.g., in a secure environment) or the secret 114 may be generated by the computing device 100 based on a value associated with an identity of the computing device 100 such as a unique identifier attributed to the computing device 100. Since the secret 114 is associated with the computing device 100 it could be referred to as a “host” secret or a “platform” secret.

In use of the computing device 100, the processor 108 is to install an administration credential 118 in the firmware 112. In some examples, the installed administration credential 118 may control whether or not the secret 114 can be obtained from the information 116, as described in more detail below.

In some examples, the administration credential 118 may be installed via a firmware management function implemented by the computing device 100.

As used herein, a firmware management function may facilitate update, repair or replacement of the firmware e.g., during boot or while an OS of the computing device is running. In some examples, the firmware management function may facilitate remote management of the firmware by an administrator of the computing device. In some examples, a cryptographic procedure such as based on public key cryptography may be implemented by the firmware in order to authenticate remote administrator access to the firmware (e.g., to allow changing firmware variables and/or provisioning of data such as user secrets). In some examples, the firmware management function may facilitate local management of the firmware by a user of the computing device.

In use of the computing device 100, the processor 108 is to transmit the secret 114 to the component 102 via the firmware 112.

The transmission of the secret 114 to the component 102 may refer to locking of the component 102 such that data stored in the component 102 is not releasable unless the firmware 112 authorizes the release of the data (e.g., based on the installed administration credential 118 as described below). In this regard, the secret 114 is useable by the component 102 to bind the component 102 to its platform (i.e., the other components of the computing device 100). Thus, the component 102 may release the data stored therein providing the component 102 can determine that the setup of the computing device 100 is as expected, and that an entity such as a user in possession of the computing device 100 is authorized to gain access to or use the data stored in the component 102.

In some examples where the locking of the component 102 is implemented, the firmware 112 may be set up to provide a user with the option (e.g., via a firmware menu displayed on a GUI associated with the computing device 100) to provide a user credential via a user input associated with the computing device 100. The user credential is to unlock the firmware 112 such that the secret 114 (controlled by the firmware 112) can be transmitted to the component 102 to facilitate access to the component 102 (based on a comparison of the user credential with the administration credential 118). If the user successfully unlocks the firmware 112 so that the secret 114 is transmitted to the component 102 to unlock the component 102, the data stored in the component 102 may be released to another component of the computing device 100 (e.g., the processor 108 so that the data can be stored in an appropriate location).

Certain examples described herein may leverage firmware management of boot time secrets to control the validity of boot time values reported to the component 102. Certain examples described herein may record boot measurements in the component 102 and deny access to the data stored in the component 102 if the component 102 is moved by an attacker to a different platform or if an attacker attempts to use the component 102 without user consent. Unless the secret 114 is transmitted (upon verification of an inputted user credential), such attacks may lead to invalid boot measurements being recorded in the component 102. Such invalid boot measurements may block release of the data from the component 102 based on a policy implemented by the component 102. Certain examples described here may reduce the need to make invasive changes to the OS stack for reducing the risk of physical attack, where such changes may otherwise lead to instabilities in or degraded performance of the OS. Certain examples described herein may reduce the need for customers to manually change policies implemented by components 102 in their enterprise.

The firmware-based locking of the component as provided by examples described herein may reduce the likelihood of data such as customer secrets from being used or extracted with low-cost physical attacks, for example, where a computing device may be intercepted in transit between trusted locations.

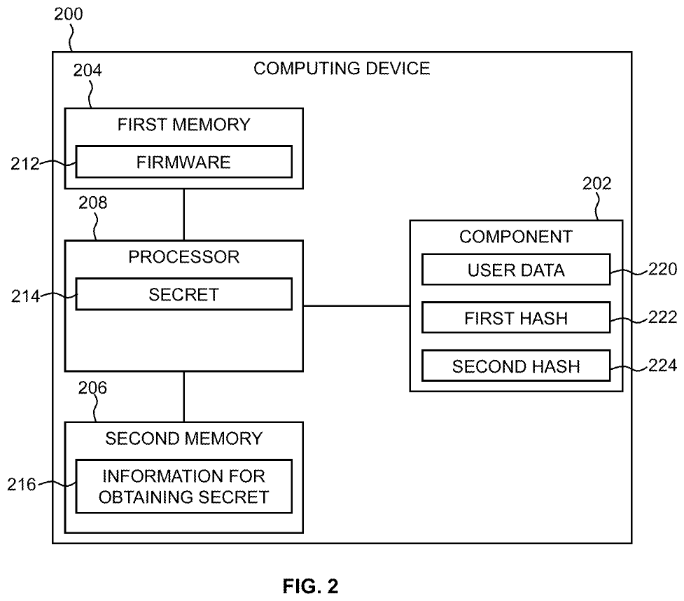

FIG. 2 is a simplified schematic drawing of an example computing device 200 for controlling obtaining of a secret. The computing device 200 implements the same functionality as the computing device 100 of FIG. 1 (i.e., locking a component 102 such that it does not release data stored therein unless the secret 114 is transmitted to the component 102), as well as implementing additional functionality relating to locking of the component 102, as described in any number or combination of the examples described below. Reference signs for features of the computing device 200 which correspond to or are similar to features of the computing device 100 of FIG. 1 are incremented by 100. Not all features of the computing device 100 are depicted or described in relation to the computing device 200 for brevity.

The computing device 200 comprises a component 202, first memory 204 comprising firmware 212, second memory 206 comprising information 216 and processor 208.

In some examples, and in use of the computing device 200, the processor 208 is to generate the information 216 for obtaining the secret 214. The information 216 is generated via the firmware 212. The processor 208 is further to store the information 216 in the second memory 206. In some examples, the processor 208 is to generate the information 216 based on a value attributed to the computing device 200 such as a unique seed or other value that can be used to derive the secret 214 (e.g., based on a deterministic protocol or other protocol implemented by the firmware 212 for determining the secret 214 based on the information 216).

However, in some examples, the information 216 may be inserted into the second memory 206 in a secure setting (e.g., the secret 214 could be generated externally of the computing device 200).

Whichever example is implemented for storing the information 216 in the second memory 206, the secret 214 may be transmitted to the component 202 at an appropriate time in order to implement the locking of the component 202. In some examples, the secret 214 may be transmitted to the component 202 before, during or after the information 216 for obtaining the secret 214 is stored in the second memory 206. In one example, the secret 214 could be generated via the firmware 212 and transmitted to the component 202 (to implement the locking of the component 202) before or during storing the information 216 in the second memory 206. In another example, the information 216 could be stored in the second memory 206, then the firmware 212 may generate the secret 214 from the information 216 and then transmit the secret 214 to the component 202 in order to implement the locking of the component 202.

In some examples, user data 220 such as a user/customer secret may be installed in the component 202 (e.g., in a secure setting such as a factory). As referred to previously, the firmware 212 may control whether or not this user data 220 is releasable from the component 202. In this regard, the component 202 may implement an access control policy (e.g., set up in the secure setting) to define whether or not the user data 220 is releasable. As described below, the access control policy may be implemented based on a value such as a hash calculated by the component 202, where the hash is calculated based on a measured state of the computing device 200, and the secret 214 transmitted to the component 202.

In some examples, the component 202 is to generate, and store in the component 202, a first hash 222 based on the secret 214 and the measured state of the computing device 200 obtained prior to transmission of the secret 214 (e.g., in order to implement the locking of the component 202). An access control policy is implemented by the component 202. According to the access control policy, the component 202 is to block access to user data 220 stored in the component 202 in response to the component 202 determining that a second hash 224 generated by the component 202 based on a re-obtained version of the secret 214 transmitted to the component 202 by the processor 208 does not match the first hash 222. The re-obtained version of the secret 214 is obtained after the access control policy is implemented. However, the component 202 is to provide the processor 208 with access to the user data 220 stored in the component 202 in response to the component 202 determining that the second hash 224 matches the first hash 222 (to thereby unlock the component 202 as a result of the firmware 212 controlled secret 214 being transmitted to the component 202). For example, the component 202 may transmit the user data 220 to the component 202 upon unlocking of the component 202. In another example, the component 202 may transmit the user data 220 to the component 202 upon receiving an explicit command to do so.

During setup of the access control policy (e.g., in a secure setting), the first hash 222 may be generated by the component 202 based on the secret 214 transmitted to the component 202 when implementing the locking of the component 202. The access control policy may be based on the first hash 222 such that, when locked, the component 202 may block access to the user data 220 unless the second hash 224 (which may be generated upon the computing device 200 being restarted by a user after the user has received the computing device 200) matches the first hash 222.

In some examples where the access control policy is being set up, the processor 208 is to provide the user data 220 to the component 202 prior to implementing the access control policy. The processor 208 is further to instruct the component 202 to implement the access control policy. For example, an authorized entity may insert the user data 220 (as may have been provided to the authorized entity by the user in advance) into the computing device 200 in the secure setting and then instruct the component 202 to implement the access control policy such that, upon being restarted, the component 202 is locked.

The component 202 may implement a security function (e.g., based on cryptography) in order to block release of the user data 220 while the component 202 is locked, unless the user is able to unlock the component 202 via the firmware 212 to allow the user data 220 to be released from the component 202, as described in more detail below. As described in the above example, a hash may be generated by the component 202 in connection with its access control policy. An example of this functionality is now described in relation to the example where the component 202 comprises a TPM (however, similar functionality may be provided by other types of components for implementing a security function).

A TPM may have the ability to record the state of a platform (i.e., the computing device 200) on which it resides. The state may be measured by firmware 212 (e.g., during booting) of the computing device 200 and be reported to the TPM. Upon receiving the reported measurement, the TPM may calculate a hash of the reported measurement. A hash chain may be securely stored in the TPM based on previously reported measurements. Thus, a change in state of the platform may be evident upon inspection of the hash chain generated based on the received sequence of measurements. An unexpected measurement in the sequence may produce a different hash chain value.

The value of the resulting hash may be used to authorize access to capabilities and/or data stored in the TPM such as allowing access when the expected hash is generated.

In some examples, the resulting hash may be stored in a TPM Platform Configuration Register (PCR) with the “TPM2_PCR_Extend” command. The TPM PCR may be reset on each start-up. In some examples, the resulting hash may be stored in a TPM non-volatile RAM (NVRAM) location (i.e., a hybrid extend index) with the “TPM2_NV_Extend” command. The “TPM2_NV_Extend” command may implement a policy that resets the value stored in the NVRAM on each start up.

In some examples, the first hash is stored in a non-volatile memory of the component 202 such that it can be accessed upon restart of the computing device 200. For example, the first hash may be stored in a target hash implemented by a policy for the target object (i.e., the computing device 200) to be managed. For example, the user data 220 can be encrypted by the component 202 with a policy specifying that the component 202 is to decrypt the user data 220 when the PCR values match the target hash (and not decrypt if the values do not match). In some examples, the component 202 may encode the policy itself as a hash comprising the target hash.

While the component 202 is locked via the firmware 212, the firmware 212 may not be able to extend the TPM PCR or NVRAM location with the secret 214 on each boot (unless the user successfully authenticates to the firmware 212 so that the secret 214 can be transmitted to the TPM to thereby unlock the TPM).

In some examples where the component 202 is locked and the component 202 comprises a TPM, the processor 208 is to transmit the secret 214 to the TPM with a command (e.g., “TPM2_PCR_Extend” or “TPM2_NV_Extend”) to instruct the TPM to generate the first hash 222 based on the secret 214. In some examples, the first hash 222 is precomputed or generated in the PCR. The first hash 222 may then be used in creating the policy for storing in a non-volatile memory location or as a protected object in the component 202.

In some examples where the user is attempting to access the user data 220 while the component 202 is locked (i.e., the access control policy has been set), the processor 208 is to, in response to determining that the TPM is implementing the access control policy, re-obtain the secret 214 from the information 216 (e.g., providing the user is authorized as described in further detail below). Further, the processor 208 is to transmit the re-obtained secret 214 to the TPM with a command to instruct the TPM to generate the second hash 224 based on the re-obtained secret 214. The command is further to instruct the TPM to release the user data 220 stored therein to the processor 208 in response to the TPM determining that the second hash 224 matches the first hash 222. A determination that the first and second hashes 222, 224 match may satisfy the access control policy to thereby facilitate release of the user data 220 (at least while the computing device 200 is running, and potentially permanently).

In some examples, the secret 214 may be transmitted to the TPM on each restart of the computing device 200 (thus extending the second hash 224 each time) so that the firmware 212 may release user data 220 stored in the TPM on each restart without further user input. However, in some examples, the TPM may not automatically release the user data 220 upon the computing device 200 being restarted if the firmware 212 no longer transmits the secret 214 upon the computing device 200 restarting (in which case further user input may be needed to re-transmit the secret 214). In some examples, further use of the secret 214 may be prevented with a disable procedure as also described in more detail below.

Although the above description refers specifically to a TPM, the described functionality may also apply to other types of component 202 for implementing a security function.

The unlocking of the component 202 via the firmware 212 to facilitate release of user data 220 from the component 202 is now described in more detail below.

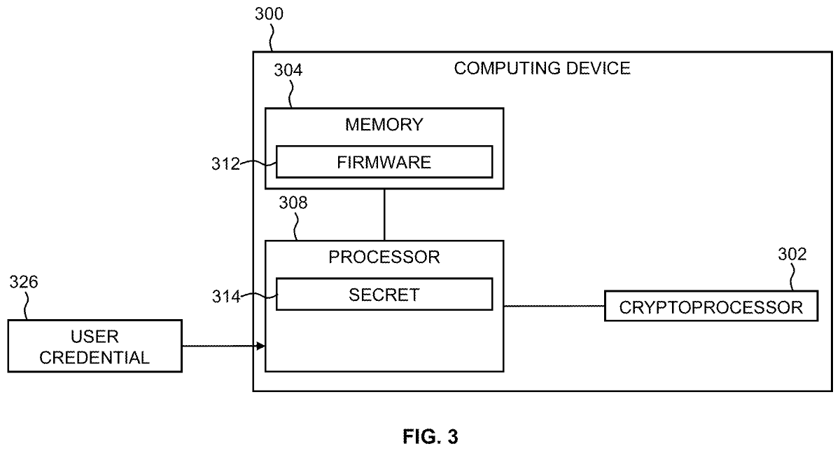

FIG. 3 is a simplified schematic drawing of an example computing device 300 for controlling transmission of a secret to a cryptoprocessor (as an example of a “component for implementing a security function”). The computing device 300 may implement the same or similar functionality as the computing devices 100 and 200 of FIGS. 1 and 2. However, the unlocking procedure is now described. Reference signs for features of the computing device 300 which correspond to or are similar to features of the computing device 200 of FIG. 2 (or other computing devices) are incremented by 100 (or as appropriate).

The computing device 300 comprises a cryptoprocessor 302, firmware 312 stored in a memory 304 of the computing device 300 and a processor 308.

In use of the computing device 300 and where the firmware 312 is in a first permission state, the processor 308 is to receive a user credential 326.

In some examples, the user credential 326 may be input to the computing device 300 via a hardware component (not shown) such as a keyboard or a touch-sensitive display device that is part of or connected to the computing device 300.

The firmware 312 may verify whether or not the user credential 326 input to the computing device 300 is to permit the firmware 312 to change its permission state. For example, the user credential 326 may be compared with a trusted credential (e.g., the administration credential 118 of FIG. 1) of the firmware 312.

In response to verifying that the user credential 326 matches the trusted credential, the processor 308 is to instruct the firmware 312 to change its permission state to a second permission state.

In the first permission state, the firmware 312 is to block the cryptoprocessor 302 from receiving a secret 314 obtainable by the firmware 312.

In the second permission state, the firmware 312 is to transmit the secret 314 to the cryptoprocessor 302.

Thus, while in the first permission state, the firmware 312 may be considered to have locked the cryptoprocessor 302. However, while in the second permission state, the firmware 312 may be considered to have unlocked the cryptoprocessor 302, e.g., at least until the computing device 300 is shut down, or potentially in a permanently unlocked state where the secret 314 is transmitted during each boot time (unless further use of the secret 314 is disabled as described below). While in the second permission state, the secret 314 may be transmitted to the cryptoprocessor 302. In order to lock the firmware 312, and hence also block release of data from the cryptoprocessor 302, the secret 314 may already have been transmitted to the cryptoprocessor 302 prior to implementing an access control policy such as described in relation to the computing device 200.

In use of the computing device 300 and while the firmware 312 is in its first permission state (i.e., a locked state), the firmware 312 may provide a prompt (e.g., in a firmware menu) asking for an unlock authorization (i.e., the “user credential” 326) to be input to the computing device 300 by the user. If this matches the trusted credential, the firmware 312 may switch to the second permission state (i.e., the firmware 312 may switch to an unlocked state). In some examples, if the unlock authorization is accepted, the firmware 312 may be permanently unlocked to provide access to data stored in the cryptoprocessor 302 (unless a user re-implements the locking of the cryptoprocessor 302). While the firmware 312 is unlocked, on each boot, the firmware 312 may transmit the secret 314 to the cryptoprocessor 302 (e.g., where the cryptoprocessor 302 comprises a TPM, the transmission may instruct the TPM to extend a TPM PCR with the secret 314).

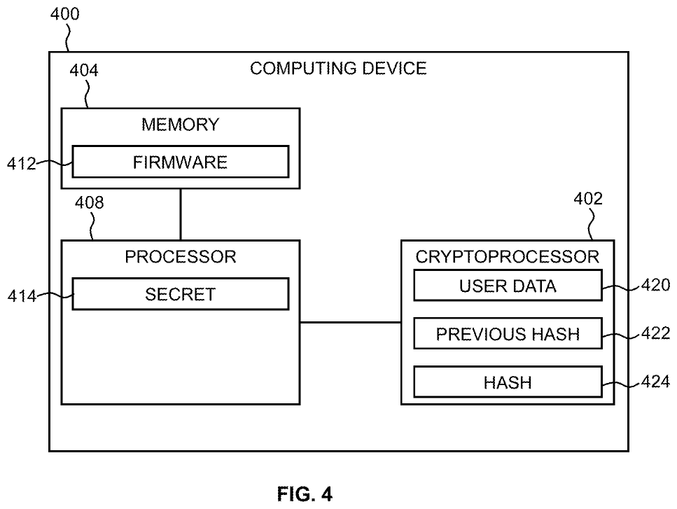

FIG. 4 depicts an example computing device 400 for controlling transmission of a secret to a cryptoprocessor. The computing device 400 implements the same functionality as the computing device 300 of FIG. 3, as well as implementing additional functionality relating to the unlocking as described in any number or combination of the examples described below. Reference signs for features of the computing device 400 which correspond to or are similar to features of the computing device 300 of FIG. 3 (or other computing devices) are incremented by 100 (or as appropriate). Not all features of the computing device 300 are depicted or described in relation to the computing device 400 for brevity.

The computing device 400 comprises a cryptoprocessor 402, memory 404 comprising firmware 412 and processor 408.

In some examples and in use of the computing device 300, the processor 408 is to transmit the secret 414 to the cryptoprocessor 302 with a command to instruct the cryptoprocessor 402 to generate a hash 424 (e.g., the “second hash” 224) from the secret 414 based on a state of the computing device 400 measured during booting of the computing device 400. For example, in the case of the cryptoprocessor 402 comprising a TPM, the command may comprise the “TPM2_PCR_Extend” command, or the like.

In some examples, the command is to instruct the cryptoprocessor 402 to release user data (e.g., customer secrets, or the like) stored in the cryptoprocessor 402 in response to the cryptoprocessor 402 determining that the hash 424 matches a previously-generated hash 422 (e.g., the “first hash” 222) generated and stored in the cryptoprocessor 402. The previously generated hash 422 may be based on the secret 414 and a state of the computing device 400 measured during a previous boot of the computing device 400 (e.g., when implementing the locking of the cryptoprocessor 402).

In some examples, the processor 408 is to, in response to the cryptoprocessor 402 releasing the user data 420, receive the user data 420 from the cryptoprocessor 402 for use by the computing device 400. In some examples, the received user data 420 may be used to implement a function of the computing device 400. For example, if the user data 420 comprises a network access credential, this may be installed on the computing device 400 (e.g., stored in a memory thereof or used in some other way) to allow the user to connect to a network accessible with the network access credential with minimal user input.

In some examples, the cryptoprocessor 402 comprises a TPM, and the command comprises a TPM extend command to instruct the hash 424 to be stored in a TPM PCR or an NVRAM location of the TPM.

Some further examples relating to unlocking of firmware to facilitate release of data are now described.

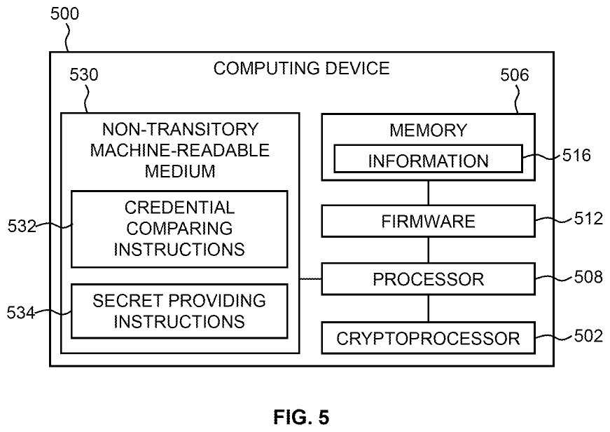

FIG. 5 is a simplified schematic drawing of an example computing device 500 for controlling providing of a secret to a cryptoprocessor.

The computing device 500 comprises a non-transitory machine-readable medium (MRM) 530 (where the term “non-transitory” as used herein does not encompass transitory propagating signals) for implementing similar functionality as the computing devices 300 and 400 of FIGS. 3 and 4. Reference signs for features of the computing device 500 which correspond to or are similar to features of the computing device 400 (or other computing devices) are incremented by 100 (or as appropriate).

The computing device 500 comprises the non-transitory MRM 530, a cryptoprocessor 502, memory 506 storing information 516, processor 508 and firmware 512 (e.g., stored in a memory of the computing device 500, which may or may not be the same as the memory 506).

The non-transitory MRM 530 stores instructions readable and executable by the processor 508. In this regard, the MRM 530 stores credential comparing instructions 532 and secret providing instructions 534.

The credential comparing instructions 532 are to instruct the processor 508 to, in response to determining that a user credential (e.g., the user credential 326 described previously) matches an administration credential (e.g., the administration credential 118 or “trusted” credential described previously) installed in the firmware 512, acquire a secret (e.g., the secret 114) from the information 516 via the firmware 512.

The credential comparing instructions 532 are further to instruct the processor 508 to, in response to determining that the user credential does not match the administration credential, block acquiring of the secret via the firmware 512.

The secret providing instructions 534 are to instruct the processor 508 to, in response to acquiring the secret, provide the secret to the cryptoprocessor 502.

In some examples, provision of the secret to the cryptoprocessor 502 may allow data stored in the cryptoprocessor 502 to be released if the computing device 500 is in the possession of an authorized user that supplied the correct user credential to the computing device 500.

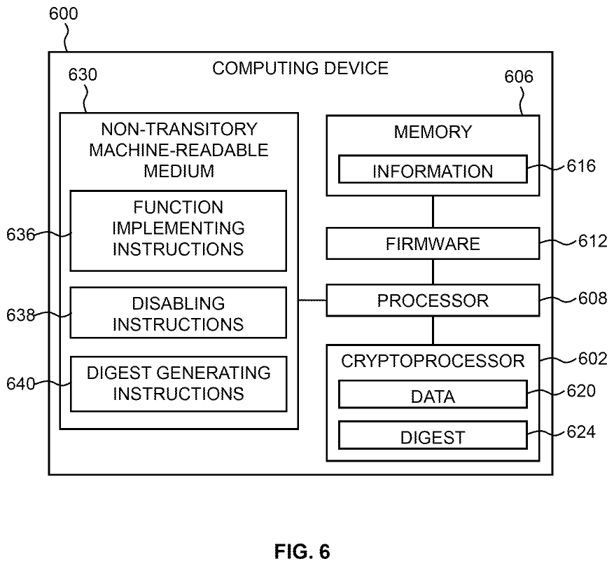

FIG. 6 is a simplified schematic drawing of an example computing device 600 for controlling providing of a secret to a cryptoprocessor.

The computing device 600 comprises a non-transitory machine-readable medium (MRM) 630 (where the term “non-transitory” as used herein does not encompass transitory propagating signals) for implementing the same functionality as the computing device 500 of FIG. 5, as well as implementing additional functionality relating to the unlocking procedure and other functions as described in any number or combination of the examples described below. Reference signs for features of the computing device 600 which correspond to or are similar to features of the computing devices 500 (or other computing devices) are incremented by 100 (or as appropriate). Not all features of the computing device 500 are depicted or described in relation to the computing device 600 for brevity.

The computing device 600 comprises the non-transitory MRM 630, a cryptoprocessor 602, memory 606 storing information 616, processor 608 and firmware 612 (e.g., stored in a memory of the computing device 600, which may or may not be the same as the memory 606).

In some examples, the cryptoprocessor 602 stores data 620 (e.g., “user data” as described previously). In some examples, the cryptoprocessor 602 stores a digest 624 (e.g., a hash such as described previously).

The non-transitory MRM 630 stores instructions readable and executable by the processor 608. The MRM 630 stores the instructions readable and executable by the MRM 530 of FIG. 5 (to implement the functionality of the computing device 500). In some examples, the MRM 630 stores function implementing instructions 636. In some examples, the MRM 630 stores disabling instructions 638. In some examples, the MRM stores digest generating instructions 640. In addition to the instructions 532, 534 implemented by the MRM 530, the MRM 630 may further store any number of combination of the instructions 636, 638, 640. The instructions 636, 638, 640 are described below.

The function implementing instructions 636 are to instruct the processor 608 to receive data 620 released by the cryptoprocessor 602 in response to the cryptoprocessor 602 being provided with the secret (e.g., as a result of executing the secret providing instructions 534). The function implementing instructions 636 are further to instruct the processor 608 to implement a function of the computing device 600 based on the data 620. In some examples, the implemented “function” may be to activate a feature of the computing device 600 based on the data 620. For example, the data 620 may comprise a network access credential, disk encryption key, etc. Such data 620 may provide the computing device 600 with access to a network, allow the computing device 600 to encrypt certain information to an entity that provided the disk encryption key in the first place, etc.

The secret may be unique for each platform instance and recorded in the cryptoprocessor 602 e.g., via a TPM PCR in the case that the cryptoprocessor 602 comprises a TPM. The use of the secret may affect remote attestation procedures implemented by the cryptoprocessor 602. This is because the recorded value (e.g., the PCR) may become unpredictable, which may make logs recorded in the cryptoprocessor 602 difficult to evaluate due to this unpredictability. Therefore, a user may wish to disable the firmware 612 controlled locking/unlocking after unlocking the cryptoprocessor 602 via the firmware 612. Disabling the firmware 612 controlled locking/unlocking may involve changing the policy (e.g., the access control policy) applied to the cryptoprocessor 602 to not include the secret described previously. The following examples describe how the disabling may be achieved.

In some examples, the user may first go through the unlocking procedure such as described in relation to the computing devices 300, 400, 500, 600. The user may then disable the access control policy applied based on their secret (e.g., by suspending an encryption function implemented by the cryptoprocessor for protecting the contents of a memory such as an HDD or flash drive of the computing device). The computing device may be restarted and the firmware may permanently disable any further use of the secret (so that it is no longer extended upon each restart). The OS may boot and any customer secrets (different to the secret associated with the computing device described previously) may be set up again with an access control policy based on the value such as the PCR (which may be no longer affected by the secret associated with the computing device). This functionality may be implemented by the disabling instructions 638 described below.

In some examples, the disabling instructions 638 are to instruct the processor 608 to, in response to the computing device 600 receiving a disable request (e.g., from the user) after receiving the data 620, disable a control policy (e.g., the “access control policy”) implemented by the cryptoprocessor 602. The control policy is to control whether the cryptoprocessor 602 is to release or block release of the data 620 stored therein. The disabling instructions 638 are further to instruct the processor 608 to disable further use of the secret by the firmware 612. Thus, in some examples, executing the disabling instructions 638 may stop the secret from being extended to cryptoprocessor 602 on each restart. In some examples, the disabling instructions 638 may facilitate a user to reset the control policy so that the recorded values (previously based on the extended secret) may no longer be based on the secret associated with the computing device 600 (and instead be based on some other values).

In some examples, the digest generating instructions 640 are to instruct the processor 608 to instruct the cryptoprocessor 602 to generate a digest 624 (e.g., a hash) based on the secret provided to the cryptoprocessor 602. The digest 624 is extended from a previously-obtained digest of a measured state of the computing device 600 received by the cryptoprocessor 602 during booting of the computing device 600. The extended digest 624 is usable by the cryptoprocessor 602 to permit data 620 to be released from the cryptoprocessor 602 for transmission to the processor 608 of the computing device 600 (e.g., based on an access control policy that uses the extended digest 624).

An example implementation of the locking and unlocking function is now described.

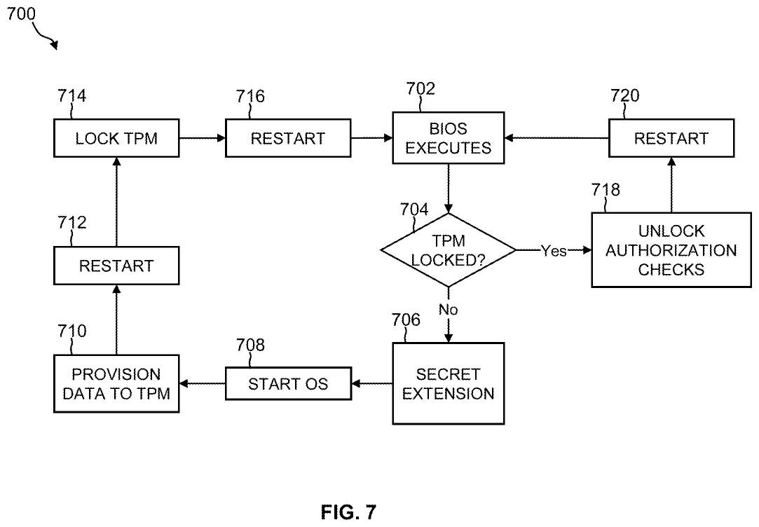

FIG. 7 depicts a flowchart of an example method 700 of locking and unlocking a trusted platform module via firmware for facilitating access to the trusted platform module. Certain blocks of the method 700 may be implemented in order to implement the functionality of certain examples of computing devices described previously. In this example, the method 700 is implemented by a computing device comprising a TPM and a basic input/output system (BIOS). However, the method 700 may equally apply to a method implemented by a computing device comprising any type of component/cryptoprocessor and firmware, such as described previously.

Thus, in some examples, the firmware may implement a BIOS which, as used herein, may refer to hardware or hardware and instructions to initialize, control, or operate a computing device prior to execution of an OS of the computing device.

In some examples, the firmware may implement the Unified Extensible Firmware Interface (UEFI) specification or another specification or standard for initializing, controlling, or operating a computing device.

Instructions included within a BIOS may be software, microcode, or other programming that defines or controls functionality or operation of a BIOS. In one example, a BIOS may be implemented using instructions, such as platform firmware of a computing device, executable by a processor. A BIOS may operate or execute prior to the execution of the OS of a computing device. A BIOS may initialize, control, or operate components such as hardware components of a computing device and may load or boot the OS of computing device.

In some examples, a BIOS may provide or establish an interface between hardware devices or platform firmware of the computing device and an OS of the computing device, via which the OS of the computing device may control or operate hardware devices or platform firmware of the computing device. In some examples, a BIOS may implement the UEFI specification or another specification or standard for initializing, controlling, or operating a computing device.

The locking function of the example method 700 is now described in relation to the blocks described below.

At block 702 of the method 700, the BIOS of a computing device executes after the computing device is turned on, thus beginning the boot process.

At block 704 of the method 700, the BIOS checks if the TPM is locked by virtue of the BIOS being in a locked state (e.g., an inputted user credential needs to match an administration credential in order to unlock the BIOS, as described in more detail below). If “no”, the BIOS/TPM are not locked and the method 700 proceeds to the next block associated with the locking procedure.

At block 706 of the method 700, a secret extension procedure is executed by the BIOS. In this regard, the BIOS checks whether the secret (associated with the computing device) exists. If not, the BIOS generates the secret and stores it (or information for obtaining the secret) in a secure storage (such as the second memory 106). However, if the secret is already obtainable, the BIOS obtains the secret and extends the TPM PCR with the secret.

At block 708 of the method 700, the BIOS starts the OS.

At block 710 of the method 700, data such as a customer secret may be provisioned to the TPM. In this regard, a check is made as to whether or not the data has already been provisioned. If not, the OS provisions the data into the TPM with the present TPM PCR value as part of a policy implemented by the TPM.

At block 712 of the method 700, the computing device is restarted e.g., by the user.

At block 714 of the method 700, a procedure for locking the TPM is implemented. In this regard, the BIOS executes during boot and the user enters a BIOS menu. The user authenticates to the BIOS (e.g., to verify that the user is trusted and installs an administration credential in the BIOS). The user enables the lock so that the BIOS marks the TPM as being locked. In other words, the BIOS is provided in a locked state to prevent the data in the TPM from being accessed.

At block 716 of the method 700, the BIOS restarts the computing device and the method 700 proceeds to block 702.

The unlocking function of the example method 700 is now described in relation to the blocks described below.

At block 704 of the method 700, if “yes” the BIOS/TPM are indeed locked, the method 700 proceeds to the next block associated with the unlocking procedure.

At block 718 of the method 700, unlock authorization checks are performed. In this regard, the BIOS asks the user to input a user credential, which is compared with the installed administration credential. If the user credential matches the administration credential, the BIOS marks the TPM as being in an unlocked state (such that the secret is extended to the TPM on each restart) and the BIOS restarts the computing device at block 720 and the BIOS executes again at block 702. However, if the user credential does not match the administration credential, the BIOS does not mark the TPM as unlocked (i.e., it is still locked) and the method 700 proceeds to block 720, and then to block 702.

In some examples, the unlock authorization check takes place after the OS has booted (rather than during boot), depending on whether the data in the TPM is needed by the OS or not.

An example implementation of the disable function is now described.

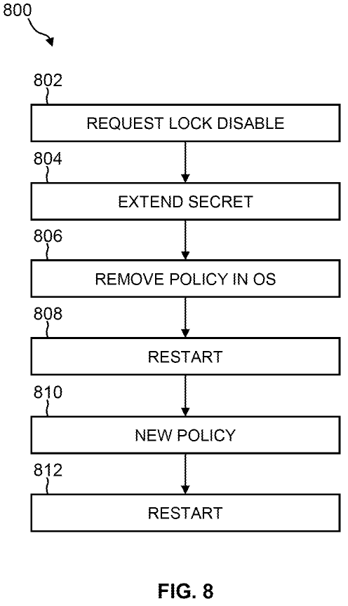

FIG. 8 depicts a flowchart of an example method 800 of firmware controlled lock disabling. Certain blocks of the method 800 may be implemented in order to implement the functionality of certain examples of computing devices described previously. Although the example method 800 refers to method implemented by a computing device comprising a TPM and BIOS, the method 800 may equally apply to a method implemented by a computing device comprising any type of component/cryptoprocessor and firmware, such as described previously.

The disable function of the example method 800 is now described in relation to the blocks described below.

At block 802 of the method 800, a user requests to disable the lock (e.g., as implemented according to the method 700). For example, a user may hit a function key on an input device during boot in order to access the BIOS menu, in which the user requests to (e.g., permanently) disable the locking of the BIOS, and hence the BIOS-controlled secret may no longer be used to lock TPM as described previously. The access to the BIOS menu may be granted upon the user authenticating to the BIOS.

At block 804 of the method 800, the secret is extended to the PCR and the BIOS boots the OS.

At block 806 of the method 800, the policy (e.g., the access control policy) is removed in the OS. Thus, the OS removes the PCR-protection of the data stored in the TPM.

At block 808 of the method 800, the computing device is restarted.

At block 810 of the method 800, the BIOS does not extend the secret into the PCR during start up and the OS provisions data into the TPM with the present PCR value (which is not extended from the secret) as part of a new/fresh policy to be implemented by the TPM.

At block 812 of the method 800, the computing device is restarted and on each restart, the secret is not extended any more, nor is access to the provisioned data on the TPM dependent on the secret as it was previously.

Any of the blocks, nodes, instructions or modules described in relation to the figures may be combined with, implement the functionality of or replace any of the blocks, nodes, instructions or modules described in relation to any other of the figures. For example, methods may be implemented as machine-readable media or computing devices, machine-readable media may be implemented as methods or computing devices, and computing devices may be implemented as machine-readable media or methods. Further, any of the functionality described in relation to any one of a method, machine readable medium or computing device described herein may be implemented in any other one of the method, machine readable medium or computing device described herein. Any claims written in single dependent form may be re-written, where appropriate, in multiple dependency form since the various examples described herein may be combined with each other.

Examples in the present disclosure can be provided as methods, systems or as a combination of machine-readable instructions and processing circuitry. Such machine-readable instructions may be included on a non-transitory machine (for example, computer) readable storage medium (including but not limited to disc storage, CD-ROM, optical storage, flash storage, etc.) having computer readable program codes therein or thereon.

The present disclosure is described with reference to flow charts and block diagrams of the method, devices and systems according to examples of the present disclosure. Although the flow charts described above show a specific order of execution, the order of execution may differ from that which is depicted. Blocks described in relation to one flow chart may be combined with those of another flow chart. It shall be understood that each block in the flow charts and/or block diagrams, as well as combinations of the blocks in the flow charts and/or block diagrams can be realized by machine readable instructions.

The machine-readable instructions may, for example, be executed by a general-purpose computer, a special purpose computer, an embedded processor or processors of other programmable data processing devices to realize the functions described in the description and diagrams. In particular, a processor or processing circuitry, or a module thereof, may execute the machine-readable instructions. Thus, functional nodes, modules or apparatus of the system and other devices may be implemented by a processor executing machine readable instructions stored in a memory, or a processor operating in accordance with instructions embedded in logic circuitry. The term ‘processor’ is to be interpreted broadly to include a CPU, processing unit, ASIC, logic unit, or programmable gate array etc. The methods and functional modules may all be performed by a single processor or divided amongst several processors.

Such machine-readable instructions may also be stored in a computer readable storage that can guide the computer or other programmable data processing devices to operate in a specific mode.

Such machine readable instructions may also be loaded onto a computer or other programmable data processing devices, so that the computer or other programmable data processing devices perform a series of operations to produce computer-implemented processing, thus the instructions executed on the computer or other programmable devices realize functions specified by block(s) in the flow charts and/or in the block diagrams.

Further, the teachings herein may be implemented in the form of a computer program product, the computer program product being stored in a storage medium and comprising a plurality of instructions for making a computer device implement the methods recited in the examples of the present disclosure.

While the method, apparatus and related aspects have been described with reference to certain examples, various modifications, changes, omissions, and substitutions can be made without departing from the scope of the present disclosure. It is intended, therefore, that the method, apparatus and related aspects be limited by the scope of the following claims and their equivalents. It should be noted that the above-mentioned examples illustrate rather than limit what is described herein, and that many implementations may be designed without departing from the scope of the appended claims. Features described in relation to one example may be combined with features of another example.

The word “comprising” does not exclude the presence of elements other than those listed in a claim, “a” or “an” does not exclude a plurality, and a single processor or other unit may fulfil the functions of several units recited in the claims.

The features of any dependent claim may be combined with the features of any of the independent claims or other dependent claims.

1. A computing device comprising:
a component, wherein the component is to perform a cryptographic operation, and wherein the component is to store an indication of a measured state of the computing device obtained during booting of the computing device;
firmware stored in a first memory of the computing device; and
a processor to:
obtain a secret for use by the component, wherein the firmware is to control obtaining of the secret, wherein the secret is obtainable from information stored in a second memory of the computing device, and wherein the secret is associated with the computing device;
install an administration credential in the firmware; and
transmit the secret to the component via the firmware.

2. The computing device of claim 1, where the processor is to:
generate the information for obtaining the secret, wherein the information is generated via the firmware; and
store the information in the second memory.

3. The computing device of claim 1, wherein the component is to generate, and store in the component, a first hash based on the secret and the measured state of the computing device obtained prior to transmission of the secret, wherein an access control policy implemented by the component is to:
block access to user data stored in the component in response to the component determining that a second hash generated by the component does not match the first hash, wherein the second hash is based on a re-obtained version of the secret transmitted to the component by the processor, and wherein the re-obtained version of the secret is obtained after the access control policy is implemented; and
provide the processor with access to the user data stored in the component in response to the component determining that the second hash matches the first hash.

4. The computing device of claim 3, where the processor is to:
provide the user data to the component prior to implementing the access control policy; and
instruct the component to implement the access control policy.

5. The computing device of claim 3, where the component comprises a trusted platform module (TPM), and where the processor is to:
transmit the secret to the TPM with a command to instruct the TPM to generate the first hash, wherein the first hash is based on the secret.

6. The computing device of claim 5, where the processor is to:
in response to determining that the TPM is implementing the access control policy, re-obtain the secret from the information; and
transmit the re-obtained secret to the TPM with a command to instruct the TPM to:
generate the second hash, wherein the second hash is based on the re-obtained secret; and
release the user data stored therein to the processor in response to the TPM determining that the second hash matches the first hash.

7. A computing device comprising:
a cryptoprocessor;
firmware stored in a memory of the computing device; and
a processor to:
where the firmware is in a first permission state, receive a user credential;
in response to verifying that the user credential matches a trusted credential, instruct the firmware to change its permission state to a second permission state, wherein:
in the first permission state, the firmware is to block the cryptoprocessor from receiving a secret obtainable by the firmware; and
in the second permission state, the firmware is to transmit the secret to the cryptoprocessor.

8. The computing device of claim 7, wherein the processor is to transmit the secret to the cryptoprocessor with a command to instruct the cryptoprocessor to generate a hash from the secret, wherein the hash is generated based on a state of the computing device measured during booting of the computing device.

9. The computing device of claim 8, wherein the command is to instruct the cryptoprocessor to:
release user data stored in the cryptoprocessor in response to the cryptoprocessor determining that the hash matches a previously-generated hash generated and stored in the cryptoprocessor, wherein the previously generated hash is based on the secret and a state of the computing device measured during a previous boot of the computing device.

10. The computing device of claim 9, where the processor is to:
in response to the cryptoprocessor releasing the user data, receive the user data from the cryptoprocessor for use by the computing device.

11. The computing device of claim 8, wherein the cryptoprocessor comprises a trusted platform module (TPM), and the command comprises a TPM extend command to instruct the hash to be stored in:
a platform configuration register (PCR) of the TPM; or
a non-volatile random-access memory (NVRAM) location of the TPM.

12. A non-transitory machine-readable medium storing instructions readable and executable by a processor of a computing device to:
in response to determining that a user credential matches an administration credential installed in firmware of the computing device, acquire a secret from information stored in a memory of the computing device via the firmware;
in response to determining that the user credential does not match the administration credential, block acquiring of the secret via the firmware;
in response to acquiring the secret, provide the secret to a cryptoprocessor of the computing device.

13. The non-transitory machine-readable medium of claim 12, wherein the processor is to:
receive data released by the cryptoprocessor in response to the cryptoprocessor being provided with the secret; and
implement a function of the computing device based on the data.

14. The non-transitory machine-readable medium of claim 13, where the processor is to:
in response to the computing device receiving a disable request after receiving the data:
disable a control policy implemented by the cryptoprocessor, where the control policy is to control whether the cryptoprocessor is to release or block release of the data stored therein; and
disable further use of the secret by the firmware.

15. The non-transitory machine-readable medium of claim 12, where the processor is to:
instruct the cryptoprocessor to generate a digest based on the secret provided to the cryptoprocessor, wherein the digest is extended from a previously-obtained digest of a measured state of the computing device received by the cryptoprocessor during booting of the computing device, and wherein the extended digest is usable by the cryptoprocessor to permit data to be released from the cryptoprocessor for transmission to the processor of the computing device.
